(19) United States
(12) Patent Application Publication
(10) Pub. No.: US 2026/0306938 A1
(43) Pub. Date: Oct. 8, 2026

(54) NON-TRANSITORY COMPUTER-READABLE STORAGE MEDIUM HAVING INFORMATION PROCESSING PROGRAM STORED THEREIN, INFORMATION PROCESSING METHOD, AND INFORMATION PROCESSING SYSTEM

(71) Applicant: NINTENDO CO., LTD., Kyoto-shi (JP)

(72) Inventor: Sho INABA, Kyoto-shi (JP)

(21) Appl. No.: 19/682,048

(22) Filed: May 19, 2026

Related U.S. Application Data
(63) Continuation of application No. PCT/JP2023/043868, filed on Dec. 7, 2023.

(51) Int. Cl. A63F 13/211; A63F 13/54; G06F 3/0346; G06F 3/0354

(52) U.S. Cl. CPC A63F 13/211; A63F 13/54; G06F 3/0346; G06F 3/03543

(57) ABSTRACT

A processor of an information processing apparatus is caused to guide a user to place a mouse on a floor, take an initial posture, and perform a posture change motion by moving the mouse placed on the floor along the floor, after taking the initial posture. Further, the processor is caused to receive first data regarding movement of the mouse, outputted from the mouse. Then, the processor is caused to evaluate the posture change motion performed by the user, based on the received first data.

### CROSS REFERENCE TO RELATED APPLICATION

This application is a continuation of International Application No. PCT/JP2023/043868, filed on Dec. 7, 2023, the entire contents of which are incorporated herein by reference.

### FIELD

The present disclosure relates to information processing using an output from a mouse.

### BACKGROUND AND SUMMARY

Conventionally, game processing using a mouse has been known.

In the above technology, there was room to provide a new way of using a mouse.

In view of the above points, for example, the following configuration examples are given.

### Configuration 1

Configuration 1 is directed to non-transitory computer-readable storage media having stored therein instructions that, when executed, cause one or more processors to perform operations comprising: guiding a user to place a mouse on a floor, take an initial posture, and perform a posture change motion by moving the mouse placed on the floor along the floor, after taking the initial posture; receiving first data regarding movement of the mouse, outputted from the mouse; and evaluating the posture change motion performed by the user, based on the received first data.

According to the above configuration example, a predetermined posture of a user and a posture change motion can be evaluated using a mouse. Accordingly, as a way of using a mouse, a way of using that has not existed conventionally can be provided.

### Configuration 2

In Configuration 2 based on the above Configuration 1, the first data for evaluating the posture change motion may be data received during a period from when a start of movement of the mouse is detected based on the first data to when it is determined based on the first data that movement of the mouse has stopped.

According to the above configuration example, the target data for evaluating the posture change motion is determined using the fact that the mouse has stopped as a trigger. Therefore, a separate operation such as pressing a predetermined button becomes unnecessary. Accordingly, simplification of the user's operation can be achieved.

### Configuration 3

In Configuration 3 based on the above Configuration 2, the game operations may comprise notifying the user, by a sound, that it has been determined that the mouse has stopped.

According to the above configuration example, user convenience can be improved. For example, depending on the posture the user is taking, a situation may occur where it is difficult for the user to visually recognize the screen, such as a posture in which the user’s face is directed toward the floor. Even in such a case, by notifying with a sound, for example, it is possible to let the user grasp that the evaluation has ended.

### Configuration 4

In Configuration 4 based on the above Configurations 1 to 3, the game operations may comprise receiving second data regarding a posture of the mouse, the second data being outputted from the mouse, and evaluating the posture change motion, based on the received second data and the first data.

According to the above configuration example, it becomes possible to evaluate even a posture change motion that cannot be evaluated only by the movement of the mouse. Alternatively, since data regarding the posture of the mouse can be used in combination, the accuracy of the evaluation of the posture change motion can be improved.

### Configuration 5

In Configuration 5 based on the above Configuration 4, the evaluation of the posture change motion may end when it has been determined that the mouse has stopped, based on the first data and the second data.

According to the above configuration example, the determination accuracy of the fact that the mouse has stopped can be improved.

### Configuration 6

In Configuration 6 based on any one of the above Configurations 1 to 5, the initial posture may be a posture in which the user sits on the floor with legs spread, the guiding may comprise instructing the user to perform, as the posture change motion, a first motion of moving the mouse forward from a crotch of the user along one of a right leg and a left leg of the user, a second motion of moving the mouse from a position to which the mouse has been moved forward along the one leg, toward the other leg, and a third motion of moving the mouse from a position to which the mouse has been moved by the second motion along the other leg, toward the crotch of the user; and the game operations may comprise evaluating at least one of the initial posture and the posture change motion, based on the first data.

According to the above configuration example, the posture and posture change motion of the user with legs spread can be measured. Alternatively, the size of the area formed inside the legs of the user with legs spread can be measured.

### Configuration 7

In Configuration 7 based on any one of the above Configurations 1 to 6, the game operations may comprise executing game processing based on a result of the evaluation.

According to the above configuration example, it is possible to impart interest to the user in taking a predetermined posture or performing a posture change motion.

According to the present disclosure, for example, information processing using a new way of using a mouse, such as evaluating a user's posture and a motion of changing the posture using the mouse, can be provided.

### BRIEF DESCRIPTION OF THE DRAWINGS

FIG. 1 is a block diagram showing a non-limiting example of a hardware configuration of an information processing apparatus 2;

FIG. 2 shows a non-limiting example of an external appearance of a mouse 40;

FIG. 3 is a diagram illustrating a first embodiment;

FIG. 4 shows a non-limiting example of various data stored in a storage section 22 of the information processing apparatus 2;

FIG. 5 is a flowchart showing details of the processing;

FIG. 6 is a flowchart showing details of the processing;

FIG. 7 is a diagram illustrating a second embodiment;

FIG. 8 is a diagram illustrating the second embodiment;

FIG. 9 is a diagram illustrating the second embodiment; and

FIG. 10 is a diagram illustrating a third embodiment.

### DETAILED DESCRIPTION OF NON-LIMITING EXAMPLE EMBODIMENTS

### Hardware Configuration of Information Processing Apparatus 2

FIG. 1 is a block diagram showing an example of a hardware configuration of an information processing apparatus 2 according to an exemplary embodiment. In FIG. 1, the information processing apparatus 2 includes a processor 21. The processor 21 is an information processing section that executes various types of information processing executed in the information processing apparatus 2. In the exemplary embodiment, the processor 21 is configured by an SoC (System-on-a-Chip) at least including a CPU (Central Processing Unit) function and a GPU (Graphics Processing Unit) function. Note that in other embodiments, the CPU and the GPU may be separate configurations. The processor 21 executes various types of information processing by executing an information processing program (for example, a game program) stored in a storage section 22. Note that the storage section 22 may be, for example, an internal storage medium such as a flash memory or a DRAM (Dynamic Random Access Memory) or may be configured to use an external storage medium or the like mounted in a slot (not shown). Note that the information processing apparatus may be, for example, a game apparatus, or may be a personal computer or a server.

Further, the information processing apparatus 2 includes a communication section 23 for performing communication with another information processing apparatus or a predetermined server.

Further, the information processing apparatus 2 includes an input device communication section 24 for the information processing apparatus 2 to perform wired or wireless communication with various input devices. Note that in the exemplary embodiment, an example in which a mouse 40 is used will be described as an example of an input device.

Further, a display section 30 (for example, a television) is connected to the information processing apparatus 2 via an image/sound output section 25. The processor 21 outputs, for example, an image and sound generated by the execution of the above information processing to the display section 30 via the image/sound output section 25.

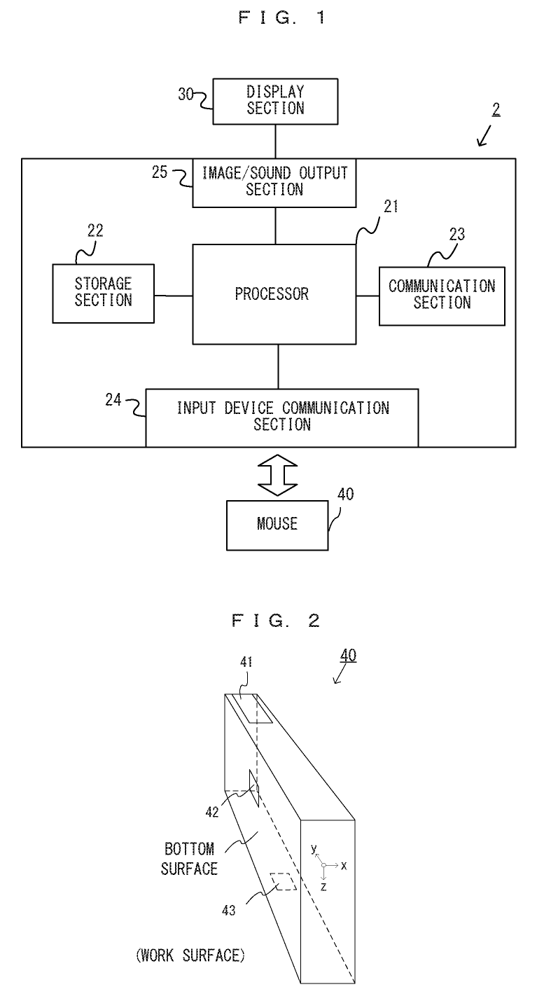

FIG. 2 is a schematic diagram showing an example of the external appearance of the mouse 40. As shown in FIG. 2, the mouse 40 has a plate shape (a rectangular parallelepiped or a shape similar thereto in which the thickness in the x-axis direction is smaller than the thickness in the y-axis direction and the z-axis direction, and the thickness in the z-axis direction is smaller than the thickness in the y-axis direction) having the y-axis direction as a longitudinal direction.

The mouse 40 includes a sensor (hereinafter referred to as a mouse sensor) that detects an operation or the like in which the user slides the mouse 40 on a work surface (a work surface with which the bottom surface is in contact, in FIG. 2). The mouse sensor is provided, for example, so as to be exposed from an opening 43 provided on the bottom surface of the mouse 40. The mouse sensor is a sensor for obtaining data for calculating movement (movement direction, movement distance, movement speed, etc.) on the work surface of the mouse 40 arranged with the bottom surface facing the work surface. The mouse sensor is, for example, an optical sensor or a laser-type sensor. Data obtained by the mouse sensor of the mouse 40 is repeatedly transmitted to the input device communication section 24 at appropriate timing.

Further, the mouse 40 includes a posture sensor. Specifically, the mouse 40 includes an acceleration sensor (not shown) and an angular velocity sensor (not shown). The acceleration sensor detects the magnitude of acceleration along predetermined three-axis (xyz axes shown in FIG. 2) directions. Note that the acceleration sensor may be one that detects acceleration in a single-axis direction or two-axis directions. Further, the angular velocity sensor detects angular velocity around predetermined three axes (xyz axes shown in FIG. 2). Note that the angular velocity sensor may be one that detects angular velocity around a single axis or two axes. Then, detection results of the acceleration sensor and the angular velocity sensor are repeatedly transmitted to the input device communication section 24 at appropriate timing.

Note that, as the posture sensor, various sensors capable of detecting posture, such as a geomagnetic sensor, may be used, or several sensors may be used in combination. Further, a combination of a plurality of optical sensors may be used as a posture sensor. For example, the mouse having been rotated or the like may be detectable based on a difference in detection values of the optical sensors (difference in movement direction, etc.).

Further, as shown in FIG. 2, the mouse 40 includes a button 41 on the top surface opposite to the bottom surface. The button 41 is located at an end in the y-axis direction of the top surface having the y-axis direction as the longitudinal direction. The user can use the button 41 as a click button. That is, the user can operate the mouse 40 by placing a hand on the top surface of the mouse 40 so that fingers are along the y-axis direction. Data indicating an operation state of the button 41 is repeatedly transmitted to the input device communication section 24 at appropriate timing.

Further, the mouse 40 may be provided with a vibration device (not shown) that vibrates the mouse 40.

### First Embodiment

Next, a first embodiment of the present disclosure will be described. As the first embodiment, for example, processing will be described in which a user is caused to take a predetermined posture (hereinafter, initial posture) on a floor, then caused to perform a motion of changing the posture (hereinafter, posture change motion), and the content of the posture change motion and the posture after the change are evaluated. As an example of such a posture change motion, there is a stretching motion. In the exemplary embodiment, as an example of the stretching motion, a motion (hereinafter, forward bending motion) in which the above initial posture is a long-sitting posture and the upper body is bent forward from this posture will be described. Then, this processing includes processing for evaluating the degree of this forward bending, that is, the flexibility of the user. The "evaluation" may be, for example, simply measuring the degree of forward bending (forward bending distance). Further, for example, the quality of flexibility may be evaluated based on the measurement result. As a specific example of this processing, for example, not only simply displaying the measurement result of the forward bending distance, but also processing such as calculating a score based on the forward bending distance or determining a parameter based on the forward bending distance and playing a game using the parameter, can be considered.

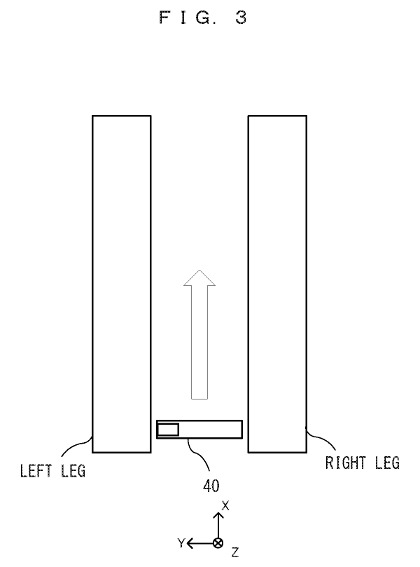

In this processing, the user is caused to take the long-sitting posture as the initial posture. FIG. 3 is a view of the user who has taken the long-sitting posture as viewed from above. Note that the torso and hands of the user are omitted in FIG. 3. Then, in this processing, as shown in FIG. 3, the mouse 40 in a horizontal posture as seen from the user is placed in front of the crotch. Hereinafter, this placement position is referred to as an “initial placement position”. Then, the user's both hands (fingertips thereof) are caused to be placed on the mouse 40. When the user is caused to perform the forward bending motion in this state, the mouse 40 moves horizontally along the forward direction of the user (the x-axis positive direction in FIG. 3) with the floor as the work surface while maintaining the horizontal posture. That is, the forward bending motion and the movement of the mouse 40 are linked. In this example, the forward bending motion is evaluated based on data regarding this movement of the mouse 40. Specifically, processing of measuring and evaluating the movement distance (forward bending distance; unit is, for example, cm) of the mouse 40 from the initial placement position is performed.

### Example of Data Used

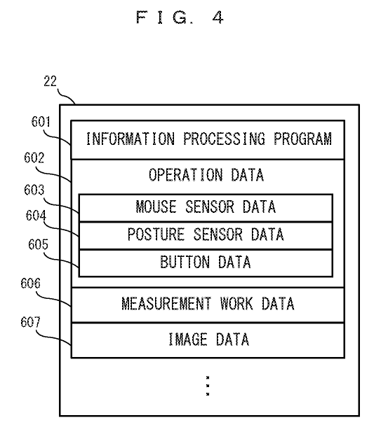

Next, details of a processing example in the first embodiment will be described. FIG. 4 is a memory map showing an example of various data stored in the storage section 22 of the information processing apparatus 2. In the storage section 22, a program 601, operation data 602, measurement work data 606, image data 607, etc., are stored.

The information processing program 601 is a program for executing the processing as described above.

The operation data 602 is data for indicating the operation content performed on the mouse 40. The operation data 602 includes mouse sensor data 603, posture sensor data 604, and button data 605. The mouse sensor data 603 is data outputted from the mouse sensor of the mouse 40. The mouse sensor data 603 includes data indicating a movement amount and a movement direction of the mouse 40 on the work surface. The posture sensor data 604 is data outputted from the posture sensor. In this example, the posture sensor data 604 includes acceleration data and angular velocity data around predetermined three axes. The button data 605 is data indicating a pressed state of each button of the mouse 40.

The measurement work data 606 is data used for measuring the forward bending distance. Specifically, the measurement work data 606 is data for temporarily storing measurement values outputted during a period (measurement period) from the start of measurement to the end of measurement. Here, regarding the "measurement value", in the following description, a total measurement value from the start of measurement to a certain point in time and a so-to-speak instantaneous measurement value measured during a very short period of, for example, one frame to several frames, will be described separately. Hereinafter, the total measurement value is referred to as a "total measurement value", and the instantaneous measurement value is referred to as an "instantaneous measurement value". Further, when simply referred to as a "measurement value", both are collectively referred to.

Note that the measurement work data 606 is not limited to directly storing measurement values, and for example, mouse sensor data 603 outputted within the measurement period may be stored. In this case, the measurement value may be calculated based on the mouse sensor data 603 within the measurement period.

The image data 607 is data that is a basis of various images displayed on the display section 30 in the above processing.

### Example of Flowcharts

Next, an example of flowcharts of processing in this example will be described. Note that, in this example, the following flowchart is realized by one or more processors reading and executing programs stored in one or more memories. The flowcharts are merely an example of the processing procedure. Therefore, the processing order of steps may be changed as long as the same result is obtained. In addition, values of variables and thresholds used in determination steps are also merely examples, and other values may be employed as necessary.

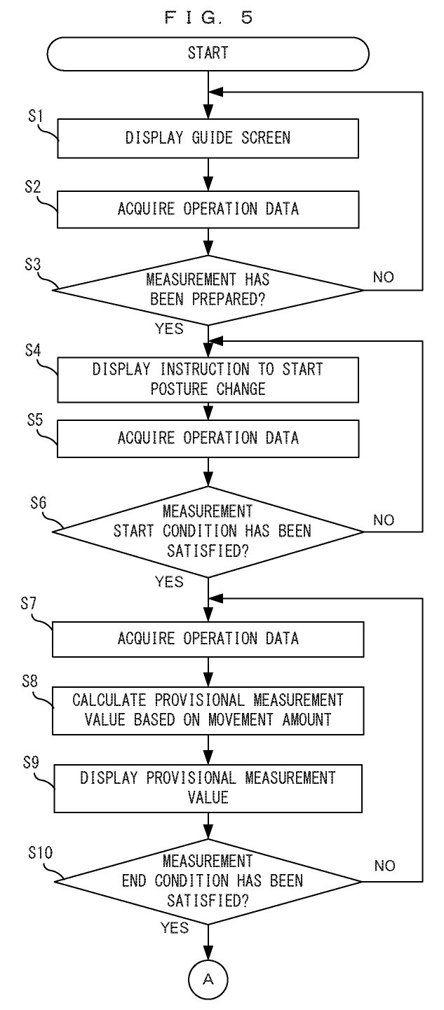

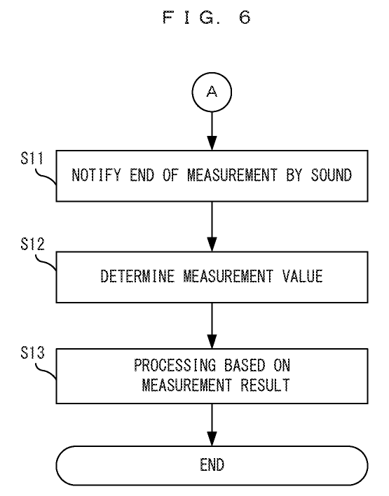

FIGS. 5 to 6 are flowcharts showing details of the above processing. In FIG. 5, first, in step S1, the processor 21 displays a guide screen. On the guide screen, an image instructing the user to take the initial posture as described above and an image instructing to place the mouse 40 at the initial placement position are displayed. Note that an announcement by sound including voice may be made.

Next, in step S2, the processor 21 acquires the operation data 602.

Next, in step S3, based on the operation data 602, the processor 21 determines whether preparation for starting measurement of the movement distance of the mouse 40 accompanying the forward bending motion (hereinafter, measurement preparation) is complete. The determination method for the measurement preparation is not limited. As an example, it may be determined that the measurement preparation is complete, when the mouse 40 has stopped for a predetermined time or more after the guide screen is displayed. As another example, it may be determined that the measurement preparation is complete, when a predetermined button is operated after the guide screen is displayed. Note that when a predetermined button operation is used for determination, for example, control may be performed such that measurement is started by a predetermined button being pressed and measurement is ended by the pressing of the button being released. That is, control may be performed such that measurement is performed while the predetermined button is being pressed. Note that, in the following description, an example of control for starting and ending measurement based on the detection result of the movement of the mouse 40 without using a button operation, will be described.

As a result of the determination, if the measurement preparation is not complete (NO in step S3), the process returns to step S1, and the processing is repeated. On the other hand, if the measurement preparation is complete (YES in step S3), next, in step S4, the processor 21 displays an image instructing to perform the posture change motion. For example, an instruction such as "Please bend your upper body forward" is displayed. Further, at this time, an image indicating a total measurement value up to the current point (hereinafter, provisional measurement value) is also displayed. Note that the initial value of the provisional measurement value is 0cm.

Next, in step S5, the processor 21 acquires the operation data 602.

Next, in step S6, the processor 21 determines whether a condition for starting measurement (hereinafter, measurement start condition) is satisfied. That is, based on the mouse sensor data 603, the processor 21 determines whether any movement has occurred from a state where the mouse 40 is stopped (a state where measurement preparation is complete). In other words, it is determined whether any input has occurred to the mouse sensor after measurement preparation is complete. As a result of the determination, if the measurement start condition is not satisfied, that is, if the mouse 40 remains stationary (NO in step S6), the process returns to step S4, and the processing is repeated.

On the other hand, if the measurement start condition is satisfied (YES in step S6), processing for measuring the movement distance of the mouse 40 is started. Specifically, first, in step S7, the processor 21 obtains operation data 602. Next, in step S8, the processor 21 calculates the movement amount of the mouse 40 based on the mouse sensor data 603. Then, the processor 21 calculates the provisional measurement value based on the movement amount. Furthermore, the processor 21 stores the provisional measurement value in the measurement work data 606.

Next, in step S9, the processor 21 performs processing for displaying the provisional measurement value. Accordingly, the user can check the movement distance from the initial placement position in real time. Further, by displaying the provisional measurement value in this way, it becomes easier for the user to understand what is being measured. Further, an operation experience like operating a real measuring instrument, in this example, a feeling of "pushing a measuring instrument”, can be provided to the user.

Next, in step S10, the processor 21 determines whether a condition for ending measurement (hereinafter, measurement end condition) is satisfied. In this example, when a state in which the mouse 40 is stopped continues for a predetermined time or more, it is estimated that the user has fully extended his/her hands, and it is determined that the measurement end condition is satisfied. Here, regarding the "state where the mouse is stopped", for example, processing may be performed assuming that the mouse has stopped, when an average movement amount during a predetermined period becomes a predetermined value or less. Further, for example, a timing when an instantaneous measurement value falls within a certain range may be regarded as a timing when the mouse 40 has stopped. This is because the timing when the instantaneous measurement value falls within a certain range is considered to be a state where the mouse 40 is stopped or close to being stopped. Note that, in other embodiments, the following methods may be used as the determination method for the measurement end condition. For example, it may be determined that the measurement end condition is satisfied when a predetermined button operation is performed. Further, for example, it may be determined that the measurement end condition is satisfied when it is detected that the mouse 40 has been lifted from the work surface.

As a result of the determination, if the measurement end condition is not satisfied (NO in step S10), the process returns to step S7, and the processing is repeated. On the other hand, if the measurement end condition is satisfied (YES in step S10), in step S11 of FIG. 6, the processor 21 outputs a predetermined sound indicating that the measurement has ended. Depending on the posture when the user is bending forward, it is also conceivable that it is difficult for the user to visually recognize the screen. Therefore, by outputting a predetermined sound when measurement is ended, it is possible to enable the user to easily recognize that the measurement has ended even when the user is unable to visually recognize the screen. Especially, when performing control to end measurement by determining that the mouse 40 has stopped, without using a button operation, such notification by sound is useful. The end of measurement may be guided by a screen. Further, at the start of measurement or during measurement, notification by sound may be made in addition to or instead of the screen display. For example, during measurement, a sound that becomes higher as the movement distance becomes longer may be outputted.

Next, in step S12, based on the measurement work data 606, the processor 21 performs processing for confirming a final total measurement value (hereinafter, confirmed measurement value). At this time, in this example, the maximum value among the provisional measurement values during the measurement period (the furthest forward bent distance) is taken as the confirmed measurement value. This is, for example, assuming a case where after the user has bent forward to the highest point, the posture has slightly returned. Note that, in other embodiments, the last measured provisional measurement value may be confirmed as the confirmed measurement value as it is.

Next, in step S13, the processor 21 performs comparison processing based on the confirmed measurement value. The comparison processing may be, for example, processing for determining whether the confirmed measurement value is higher or lower than a predetermined value. As an example of the predetermined value, for example, comparing with an average value of movement distance (forward bending distance) of the mouse 40 at the user's age, etc., may be performed. For example, in step S9, by displaying a predetermined value together with the provisional measurement value, an element that the user can use the predetermined value as a goal can be presented to the user when the user performs the forward bending motion. Alternatively, a sound may be outputted so that whether the provisional measurement value has exceeded a predetermined value can be known by sound.

In this way, in the first embodiment, the user is caused to take an initial posture and then change the posture from there. At this time, the movement of this posture change and the movement of the mouse 40 are linked. Then, processing of evaluating the content of the change is performed. Accordingly, it is possible to provide the user with a novel use of the mouse 40, previously unavailable, in which changes in the user’s posture are evaluated using the mouse 40.

### Second Embodiment

Next, a second embodiment of the present disclosure will be described. In the second embodiment, a processing example will be described in which a user is caused to take a certain posture and the posture is evaluated. As an example of a posture to be evaluated in the second embodiment, for example, an open-leg posture will be described as an example. That is, the user is caused to take a posture of spreading both legs in a long-sitting position. Then, this open-leg angle is evaluated. So to speak, it is processing for evaluating the initial posture itself.

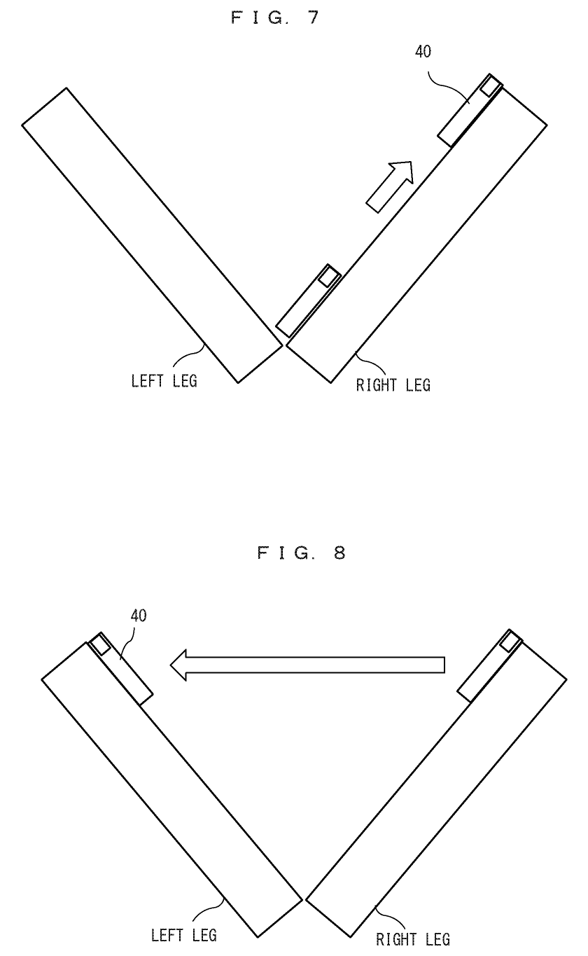

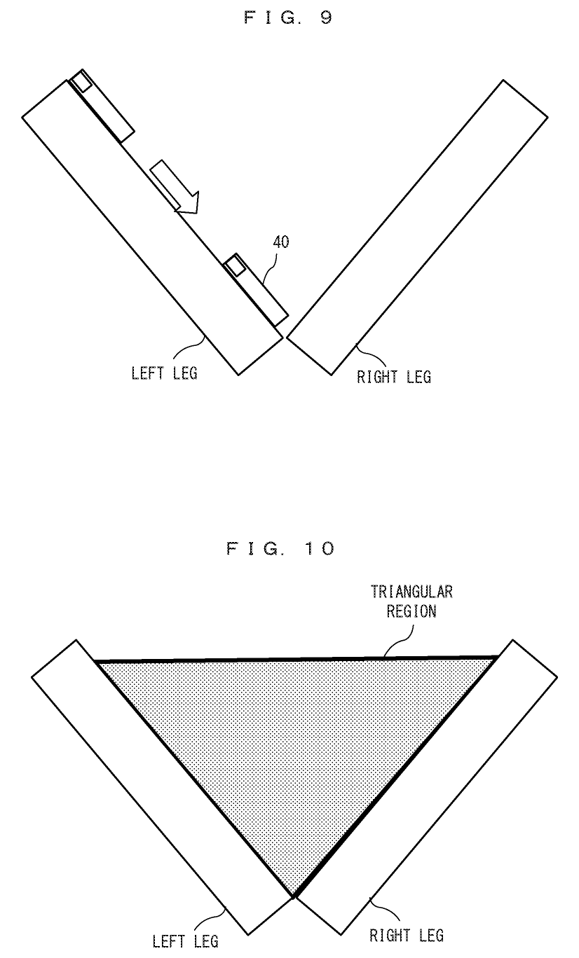

In the second embodiment, the open-leg angle is calculated using the mouse 40 as follows. (1) First, the user is caused to place the mouse 40 in front of the crotch (base of both legs) in an open-leg posture. (2) Next, the user is caused to bend forward such that the right-side surface of the mouse 40 is aligned with the right leg. Accompanying this, as shown in FIG. 7, the mouse 40 moves forward along the right leg. (3) Next, while maintaining the forward bent state, as shown in FIG. 8, the mouse 40 is horizontally moved from the right leg to the left leg. (4) Next, as shown in FIG. 9, the mouse 40 is moved toward the front of the crotch while the left side surface of the mouse 40 is aligned along the left leg. Accordingly, the mouse 40 moves to the front of the crotch along the left leg. By causing the user to perform such a motion, (A) a distance (first distance) from the front of the crotch (base of the leg) to the forward bent position of the right leg, (B) a distance (second distance) from the forward bent position of the right leg to the forward bent position of the left leg, and (C) a distance (third distance) from the forward bent position of the left leg to the front of the crotch, can be measured based on the output of the mouse sensor. Then, the open-leg angle is calculated based on these distances.

Note that, depending on how the mouse 40 is moved as shown in FIGS. 7 to 9 above, not only the open-leg but also forward bending may be measured simultaneously, or only forward bending may be measured. As an example, forward bending along the right leg and forward bending along the left leg may be measured.

Further, when performing processing using the triangulation method, output data of the posture sensor may be further used in combination. For example, based on the output data of the posture sensor, a rotation angle around the z-axis of the mouse 40 when the mouse 40 is aligned with the right leg (right leg angle) and a rotation angle around the z-axis of the mouse 40 when the mouse 40 is aligned with the left leg (left leg angle), are calculated. The rotation angle of the mouse 40 when the mouse 40 is aligned with each leg is considered to approximate an angle at which each leg is opened. Therefore, the open-leg angle may be calculated from these angles. Then, a final open-leg angle may be obtained from the open-leg angle calculated by the above method and the open-leg angle calculated based on the posture sensor. For example, an average value of open-leg angles obtained from each method is adopted, etc. In this way, by using the angle based on the mouse sensor and the angle based on the posture sensor in combination, measurement accuracy can be improved. Further, even for a posture change motion for which evaluation is difficult with only movement of the mouse 40, evaluation becomes possible. Note that, in other embodiments, the open-leg angle may be calculated using only the output of the posture sensor described above.

Note that, when using the posture sensor, the output data of the posture sensor may be used for detection of a "state where the mouse is stopped" used as the trigger for the measurement start and measurement end described above. For example, in addition to the mouse not being moved, a condition may be used for determining a “stopped state” in which the user’s posture has not changed for a predetermined period of time, or in which any change in posture, if present, is extremely small. Accordingly, the timing of measurement start and end can be determined more accurately.

Further, when using the mouse sensor and the posture sensor in combination, in other embodiments, the user's open-leg posture may be evaluated using a method such as the following. For example, the mouse 40 is placed along the tip of the right leg in an open-leg state and is then moved from that position to the tip of the left leg so that the mouse 40 is placed along the left leg. Based on a change in the posture of the mouse 40 at this time, an open-leg angle is calculated. Furthermore, based on the movement distance of the mouse at this time, a distance between the right leg and the left leg is calculated. Then, based on both, the open-leg posture of the user may be evaluated.

Note that, regarding the movement method for the mouse 40 in the case of using only the posture sensor, for example, the user may be caused to perform a movement method such as the following. First, as an initial placement position, the mouse 40 is placed in a longitudinal posture at a position that is approximately the middle of both open legs (for example, approximately the center of a straight line connecting both knees). Next, the mouse 40 is moved toward the right leg and is brought into contact along the right leg. Next, the mouse 40 is moved toward the left leg and is brought into contact with the mouse 40 along the left leg. In this way, by presenting to the user a movement in which the mouse 40 is initially placed approximately at the middle of both open legs and then brought into contact with the right leg, it is possible to more clearly convey to the user what kind of movement should be performed. Note that, when measuring the open-leg angle with such a movement method, for example, the timing when the mouse 40 is brought into contact with the right leg (timing when the mouse temporarily stops) may be the measurement start timing. Further, the timing when the mouse 40 begins to be moved from the initial placement position toward the right leg may be the measurement start timing.

Further, during the above measurement, a state in which the mouse 40 moves may be displayed on the screen. For example, a screen may be displayed in which a mouse object moves between two leg objects. For example, as the mouse 40 moves toward the right leg, the mouse object may be moved toward the right leg object. At this time, although the mouse object has touched the right leg object, it is conceivable that the actual mouse 40 still continues to move toward the right leg. At this time, according to the movement of the mouse 40, the right leg object and the mouse object in contact with the right leg object may be rotated in a direction to further spread the legs, that is, in the right direction. The same applies to the left leg object. By doing so, the user can get a sense of spreading his/her legs, and motivation for spreading legs is improved. Note that, contrary to the above, before the mouse object touches the right leg object, if the actual mouse 40 touches the right leg and stops moving further, there is a risk of giving the user a sense of discomfort. Therefore, the open-leg degree of both leg objects on the screen may be set to a relatively small angle such that the mouse object comes into contact when the mouse 40 is moved slightly. For example, the mouse object may be set to an angle on the premise that the mouse object contacts the right leg object, and if movement (angle change) of the mouse 40 stops during measurement before the mouse object contacts the right leg object, the situation may be determined as a measurement error.

### Third Embodiment

Next, a third embodiment of the present disclosure will be described. This example is an example of game processing using the open-leg posture as shown in the second embodiment above. More specifically, it is an example of game processing using a region that is approximately a triangle derived from the open-leg posture (hereinafter, triangular region) as shown in FIG. 10. The triangular region can be derived using a method as described in the second embodiment above. That is, it is a triangular region whose vertices are the position of the crotch, the forward bent position of the right leg, and the forward bent position of the left leg. Further, since the open-leg angle and forward bending distance can be different values for each user, the size and shape of the triangular region can be different depending on the user. Note that, for example, a fan shape and a trapezoidal shape are also included in the approximately triangular shape.

In this game, before starting play, processing for determining the shape and size of the triangular region is performed by causing the user to perform the movement method for the mouse 40 as shown in FIGS. 7 to 9 above. In other words, processing for measuring the movable range of the mouse 40 is performed. Furthermore, processing for associating the triangular region with a partial region in the virtual space is performed. For example, as the triangular region is larger, the region associated within the virtual space becomes larger. In the association, the entire region of the triangular region may be used, or only a part may be used. Then, during game play, by the user moving the mouse 40 within the associated triangular region, a virtual object is moved within the region of the virtual space corresponding to the triangular region. At this time, the forward bending motion as described above may be requested as the motion of moving the mouse 40. In this case, game processing using the open-leg posture and the forward bending motion can be provided. Note that regardless of the shape and size of the triangular region, the shape and size of the region associated within the virtual space may be constant. However, the movement amount of the virtual object within the region with respect to the movement amount of the mouse 40 may be changed so as to correspond to the measured triangular region or the movable range of the mouse. For example, when the size of the triangular region is large, the movement amount of the virtual object with respect to the movement amount of the mouse 40 may be made smaller than when it is small. Accordingly, for example, the virtual object can be moved to every corner of a constant region regardless of the user's flexibility.

As a specific example of a game, for example, there is a game in which the user acts as a goalkeeper and blocks incoming shots. In this case, the triangular region is associated with a goal frame in the virtual space. Then, when a shot is directed toward a certain virtual position within the goal frame in the virtual space, by moving the mouse 40 to a real position within the triangular region corresponding to the virtual position, a hand object is moved in the virtual space and the shot is blocked.

Note that in such a game, as described above, depending on the posture when the user is bending forward, it is also conceivable that the user has difficulty in visually recognizing the screen. Therefore, situations in the game may be notified by sound. For example, a direction in which a shot comes may be notified by sound, or whether the shot could be caught or blocked may be notified by sound. By using such sound guidance in combination, it is possible to more effectively improve the interest of the game.

Further, although the shape and size of the region associated within the virtual space are changed according to the shape and size of the triangular region, the shape and size of the region may be constant. At this time, the movement amount of the virtual object within the region with respect to the movement amount of the mouse 40 may be changed so as to correspond to the measured triangular region or the movable range of the mouse. For example, when the size of the triangular region is large, the movement amount of the virtual object with respect to the movement amount of the mouse 40 may be made smaller than when it is small. Accordingly, for example, the virtual object can be moved to every corner of a predetermined region in the virtual space regardless of the user's flexibility.

Further, although game processing is executed using the triangular region based on the evaluation result in the exemplary embodiment, instead of the triangular region, regions of other shapes may be used, or a range or a trajectory may be used. For example, game processing may be executed using the movement distance or movement range of the mouse 40 based on the user's forward bending motion in the first embodiment.

### Modifications

Note that, in the above embodiments, the mouse sensor detects the movement of the mouse and outputs its movement direction, movement amount, etc. In other embodiments, the mouse sensor may output only data regarding reflected light from the work surface, and the information processing apparatus 2 may output whether there has been movement of the mouse, movement direction, movement amount, etc., based on the data. Further, in the above example, the information processing apparatus 2 calculates the current position of the mouse in the mouse coordinate system. However, the mouse sensor may calculate the current position of its own mouse and transmit data regarding this to the information processing apparatus 2. Further, neither the information processing apparatus 2 nor the mouse sensor needs to calculate the current position of the mouse 40. The same applies to the posture sensor, and either the information processing apparatus 2 or the mouse 40 may calculate the actual posture.

Further, the shape of the mouse 40 in the above embodiments is an example. For example, the mouse may include a grip that is easy for the user to grasp and lift. As an example, the mouse 40 may be used like a general game controller. That is, a game controller having a mouse sensor is included in the scope of the mouse 40 in the present disclosure. Further, the mouse 40 may be attachable to and detachable from another apparatus.

Further, as another example of the method of simultaneously measuring the forward bending distance and the open-leg posture as above, for example, a method may be used in which a forward bending motion with the right leg and a forward bending motion with the left leg are performed in order. Specifically, in a state where the user's legs are spread, first, the user is caused to perform the forward bending motion such that the mouse 40 is aligned with the right leg. Next, (after temporarily returning the posture,) the user is caused to perform a forward bending motion such that the mouse 40 is aligned with the left leg. Even in this method, the forward bending distance can be measured based on the movement amount of the mouse 40 in the forward bending motion, and the open-leg angle can be calculated based on the posture when the mouse 40 is aligned with each leg.

Further, in the above example, an example of using only one mouse 40 is given, but two mice 40 may be used. In this case, one value may be evaluated using two mice, or each value may be evaluated by the corresponding mouse. For example, one value, which is opening of hands during forward bending, may be evaluated using two mice, or forward bending along the right leg with one mouse and forward bending along the left leg with the other mouse may be evaluated simultaneously or individually, respectively.

Further, the mouse 40 may be provided with a vibrator, and the vibrator may be vibrated. At this time, the vibrator may be vibrated at the timing of measurement start and end in the posture change motion. Alternatively, vibration may be continued during measurement, and the vibration may be stopped with the end of measurement. Accordingly, it becomes easier for the user to grasp that measurement has started or ended.

Further, in the above embodiments, the forward bending motion is exemplified as an example of the posture change motion, but the processing is not limited to this and can be applied to other posture change motions that can be linked with the movement of the mouse 40.

Further, regarding the measurement processing for the open-leg angle shown in the second embodiment above, it is not limited to evaluating the user's open-leg angle, and it can also be used for measuring an interior angle of two objects arranged so as to form a triangular region as described above. The measurement processing can be used when determining the arrangement positions of two predetermined objects, etc.

Further, in the above embodiment, a case where the above processing is executed by a single information processing apparatus 2 is described. The information processing apparatus 2 may include a plurality of storages and processors. Then, the above processing may be executed while being shared by these components. Further, the information processing apparatus may be a server, and the above processing may be executed in a distributed system consisting of a plurality of information processing apparatuses including the server.

Further, in other embodiments, the user may be caused to place and move the mouse on a surface other than on the floor. As an example, the user may be caused to take a predetermined posture by placing and moving the mouse on the surface of the user's body.

While the present disclosure has been described herein, it is to be understood that the above description is, in all aspects, merely an illustrative example, and is not intended to limit the scope thereof. It is to be understood that various modifications and variations can be made without deviating from the scope of the present disclosure.

### INDUSTRIAL APPLICABILITY

The information processing program, information processing method, and information processing system according to the present disclosure can provide a new way of using a mouse.

What is claimed is:

1. One or more non-transitory computer-readable storage media having stored therein instructions that, when executed, cause one or more processors to perform game operations comprising:
guiding a user to
place a mouse on a floor,
take an initial posture, and
perform a posture change motion by moving the mouse placed on the floor along the floor, after taking the initial posture;
receiving first data regarding movement of the mouse, the first data being outputted from the mouse; and
evaluating the posture change motion performed by the user, based on the received first data.

2. The one or more non-transitory computer-readable storage media according to claim 1, wherein the first data for evaluating the posture change motion is data received during a period from when a start of movement of the mouse is detected based on the first data to when it is determined based on the first data that movement of the mouse has stopped.

3. The one or more non-transitory computer-readable storage media according to claim 2, wherein the game operations comprise notifying the user, by a sound, that it has been determined that the mouse has stopped.

4. The one or more non-transitory computer-readable storage media according to claim 1, wherein the game operations comprise:
receiving second data regarding a posture of the mouse, the second data being outputted from the mouse; and
evaluating the posture change motion, based on the received second data and the first data.

5. The one or more non-transitory computer-readable storage media according to claim 4, wherein the evaluation of the posture change motion ends when it has been determined that the mouse has stopped, based on the first data and the second data.

6. The one or more non-transitory computer-readable storage media according to claim 1, wherein
the initial posture is a posture in which the user sits on the floor with legs spread,
the guiding comprises instructing the user to perform, as the posture change motion, a first motion of moving the mouse forward from a crotch of the user along one of a right leg and a left leg of the user, a second motion of moving the mouse from a position to which the mouse has been moved forward along the one leg, toward the other leg, and a third motion of moving the mouse from a position to which the mouse has been moved by the second motion along the other leg, toward the crotch of the user, and
the game operations comprise evaluating at least one of the initial postures and the posture change motion, based on the first data.

7. The one or more non-transitory computer-readable storage media according to claim 1, wherein the game operations comprise executing game processing based on a result of the evaluation.

8. A computer-implemented method comprising:
guiding a user to
place a mouse on a floor,
take an initial posture, and
perform a posture change motion by moving the mouse placed on the floor along the floor, after taking the initial posture;
receiving first data regarding movement of the mouse, the first data being outputted from the mouse; and
evaluating the posture change motion performed by the user, based on the received first data.

9. The computer-implemented method according to claim 8, wherein the first data for evaluating the posture change motion is data received during a period from when a start of movement of the mouse is detected based on the first data to when it is determined based on the first data that movement of the mouse has stopped.

10. The computer-implemented method according to claim 9, comprising notifying the user, by a sound, that it has been determined that the mouse has stopped.

11. The computer-implemented method according to claim 8, comprising:
receiving second data regarding a posture of the mouse, the second data being outputted from the mouse; and
evaluating the posture change motion based on the received second data and the first data.

12. The computer-implemented method according to claim 11, wherein the evaluation of the posture change motion ends when it has been determined that the mouse has stopped, based on the first data and the second data.

13. The computer-implemented method according to claim 8, wherein
the initial posture is a posture in which the user sits on the floor with legs spread,
the guiding comprises instructing the user to perform, as the posture change motion, a first motion of moving the mouse forward from a crotch of the user along one of a right leg and a left leg of the user, a second motion of moving the mouse from a position to which the mouse has been moved forward along the one leg, toward the other leg, and a third motion of moving the mouse from a position to which the mouse has been moved by the second motion along the other leg, toward the crotch of the user, and
the method comprises evaluating at least one of the initial postures and the posture change motion, based on the first data.

14. The computer-implemented method according to claim 8, comprising executing game processing based on a result of the evaluation.

15. An information processing system comprising:
a mouse equipped with an optical sensor;
one or more processors; and
one or more memories storing instructions that cause the one or more processors to perform game operations comprising:
transmitting, from the mouse, first data regarding movement of the mouse on a work surface, based on an output from the optical sensor;
guiding a user to
place the mouse on a floor,
take an initial posture, and
perform a posture change motion by moving the mouse placed on the floor along the floor, after taking the initial posture;
receiving the first data from the mouse; and
evaluating the posture change motion performed by the user, based on the received first data.

16. The information processing system according to claim 15, wherein the first data for evaluating the posture change motion is data received during a period from when a start of movement of the mouse is detected based on the first data to when it is determined based on the first data that movement of the mouse has stopped.

17. The information processing system according to claim 16, wherein the game operations comprise notifying the user, by a sound, that it has been determined that the mouse has stopped.

18. The information processing system according to claim 15, wherein the game operations comprise:
receiving second data regarding a posture of the mouse, the second data being outputted from the mouse; and
evaluating the posture change motion based on the received second data and the first data.

19. The information processing system according to claim 18, wherein the evaluation of the posture change motion ends when it has been determined that the mouse has stopped, based on the first data and the second data.

20. The information processing system according to claim 15, wherein the game operations comprise executing game processing based on a result of the evaluation.
